(19) United States
(12) Patent Application Publication
(10) Pub. No.: US 2008/0217994 A1
(43) Pub. Date: Sep. 11, 2008

(54) Idler for crawler track

(76) Inventors: Brian Donald McRae, Withcott (AU); Arthur Reginald McNae, Ormeau (AU)

Correspondence Address: WELLS ST. JOHN P.S., 601 W. FIRST AVENUE, SUITE 1300, SPOKANE, WA, 99201, US

(21) Appl. No.: 11/715,083

(22) Filed: Mar. 6, 2007

(51) Int. Cl. B62D 55/14

(52) U.S. Cl. 305/199; 305/196

(57) ABSTRACT

An idler for use on a tracked vehicle of the type having a track that includes a plurality of track links joined together, which track links pass around the idler. The idler includes a plurality of generally flat surfaces that come into contact with corresponding generally flat surfaces on the track links as the track links pass around the idler. Reduced wear results. The generally flat surfaces on the idler may be provided by removable wear plates.

### FIELD OF THE INVENTION

The present invention relates to an idler for use with crawler tracks.

### BACKGROUND TO THE INVENTION

Crawler tracks (which are also commonly referred to as “caterpillar tracks”) are widely used in vehicles that are used for mining, construction, excavation, agricultural and military purposes. Crawler tracks are typically assembled from track links which are joined together to form a closed loop or chain. The joint between each track link allows relative pivotal movements between the track links. This enables the track to be flexible and maintain its shape. The track links carry track shoes or track plates that form the ground engaging surface of the track.

FIG. 1 shows a side view of the track link that is commonly used in crawler tracks. FIG. 2 shows an underneath view of the track link shown in FIG. 1. The track link 10 is typically made from steel. It includes a body 11 having openings 12, 13 that, in use, accept connection pins that allow adjacent track links to be connected to each other.

As shown in FIG. 2, the underneath surface 16 (which, in use, forms an inner surface of the track) includes a central portion 17 and offset end portions 18, 19.

In order to assemble a track, a number of track links are positioned as shown in FIG. 3. The offset end portions 18 and 19 are arranged such that the end portion 18 of one track link overlaps with the corresponding end portion 19 of an adjacent track link. A connecting pin 20 (refer to FIG. 4) is then inserted through the respective openings 12, 13 in the offset end portions 18, 19 to connect the track links together. The track links are connected together until a complete loop is formed. This loop effectively forms a chain.

As shown in FIG. 4, the chain 21 of connected track links carries track shoes 22. The track shoes 22 engage with the ground when the vehicle is being driven.

FIGS. 5 and 6 show side schematic views of possible arrangements of the tracks. In FIG. 5, the track 23 (which includes the track links 10 and track shoes 22) is arranged to extend around a drive sprocket 24 and an idler 25. Idler 25 is not a driven wheel and acts to guide the track.

FIG. 6 shows an alternative track layout for a track on a vehicle. The layout shown in FIG. 6 is frequently used on larger tracked vehicles. In the embodiment shown in FIG. 6, the track 23 extends around a drive sprocket 26, a major bogie 27 and an idler 28.

It will be appreciated that the tracks shown in FIGS. 5 and 6 may include other components, such as minor bogies, track rollers, carrier rollers and the like.

In some tracks, a single loop of track links is used to carry the track shoes. In other tracks, two layers of track links that are spaced apart from each other are used to carry the track shoes. This affords greater strength and stability, particularly where the track is used on a large, heavy vehicle.

Interaction between the track links and the idler causes wear of the track links. As the track links move over the idler, the inner surfaces of the track links come into contact with the idler. This contact results in an arcuate wear pattern being formed on the inner surfaces of the track links. This wear decreases the usable service life of the track links and necessitates repair or replacement.

U.S. Pat. No. 6,536,853 (which the applicant does not concede forms part of the common general knowledge in Australia) addresses the issue of wear in the lower surface of the track links by providing an idler having a circumferentially extending surface. The circumferentially extending surface has a first notch and a second notch defined therein. The notches on the circumferential part of the idler are sized and positioned such that they contact bushes that are used to connect the track links together. The bushes and the notches in the idler have complementary conformal surfaces that result in the wear on the idler and the track link being significantly reduced.

Throughout this specification, the word “comprising” and its grammatical equivalents shall be taken to have an inclusive meaning unless the context indicates otherwise.

### BRIEF DESCRIPTION OF THE INVENTION

In a first aspect, the present invention provides an idler for use on a tracked vehicle of the type having a track that includes a plurality of tracks links joined together, said track links passing around the idler, said idler including a plurality of generally flat surfaces that come into contact with corresponding generally flat surfaces on the track links as the track links pass around the idler.

Preferably, each of the plurality of flat surfaces on the idler have a length that matches the link pitch of the track chain formed by the track links.

In some vehicles, the track comprises two chains of track links that support track shoes, the two chains of track links being spaced laterally from each other, the chains of track links passing around the idler as the vehicle moves, the idler comprising a region of larger diameter having a width that allows the region of larger diameter to fit into the space between the two chains of track links and lateral regions located on either side of the region of larger diameter, the lateral regions including a plurality of generally flat surfaces that come into contact with corresponding generally flat surfaces on the track links.

The idler in accordance with the present invention reduces wear on the track links because the link contacts a flat surface as it passes over the idler. This avoids the scalloping wear patterns on the track links that arise from using conventional idlers.

In some embodiments, the generally flat surfaces may be provided by wear plates mounted to the idler. The wear plates may be removably mounted to the idler. Appropriate fastening means may be used to removably mount the wear plates to the idler. The wear plates or the idler may be provided with a key to assist in locating the wear plate. The key may be formed with the wear plate and the key may fit into a slot in the idler. Alternatively, the key may be formed with the idler and the wear plate may be provided with a sot. In a further alternative, both the idler and the wear plate may be provided with slots and a key may be inserted into the slots.

In a second aspect, the present invention provides a track assembly that includes a drive sprocket and an idler, a track comprising a plurality of track links joined together to form a track chain, the track links carrying track shoes, with the idler being as described with reference to the first aspect of the present invention.

In some embodiments, the track assembly includes two track chains that are spaced apart from each other.

The present invention also provides a tracked vehicle that includes an idler as described in relation to the first aspect of the present invention.

### BRIEF DESCRIPTION OF THE DRAWINGS

FIG. 1 shows a side elevational view of a conventional track link;

FIG. 2 shows an underneath view of the lower surface or inner surface of the track link shown in FIG. 1;

FIG. 3 shows an underneath view of part of a track chain made fromjoined track links;

FIG. 4 shows a side elevation view of a track assembly comprising a track chain carrying track shoes;

FIG. 5 shows a schematic side view of one possible arrangement of a track used on a tracked vehicle;

FIG. 6 shows a schematic side view of another track assembly for use on a tracked vehicle;

FIG. 7 shows a perspective view of an idler in accordance with an embodiment of the present invention;

FIG. 8 shows a side elevation view of the idler shown in FIG. 7;

FIG. 9 shows an end elevation view of the idler shown in FIG. 7;

FIG. 10 shows a side view of the idler shown in FIGS. 7 to 9 with a track chain passing over the idler;

FIG. 11 shows a side perspective view of an idler similar to that shown in FIG. 7, but with the generally flat surfaces being formed by removable wear plates; and

FIG. 12 shows a perspective view of an idler that is similar to that shown in FIG. 11 and incorporating a key between the wear plate and the idler to assist in locating the wear plate.

### DETAILED DESCRIPTION OF THE DRAWINGS

The drawings have been provided for the purpose of illustrating preferred embodiments of the present invention. Thus, it will be appreciated that the present invention should not be considered to be limited to the embodiments shown in the drawings.

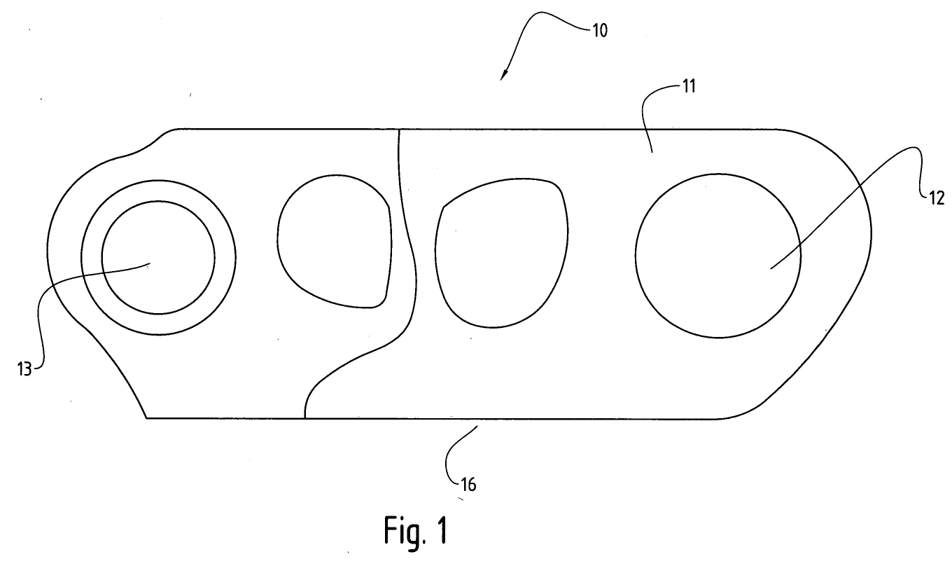

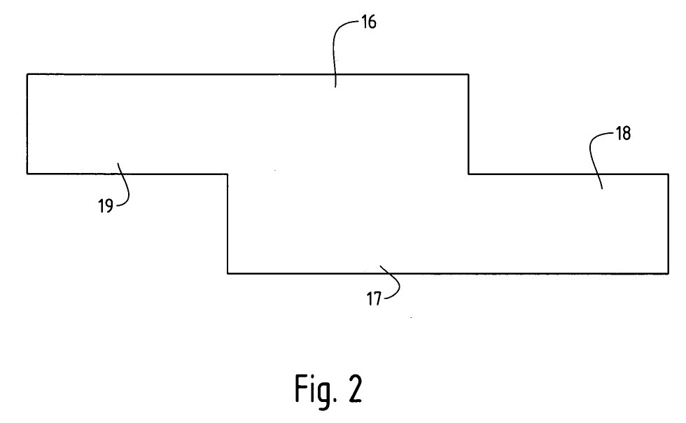

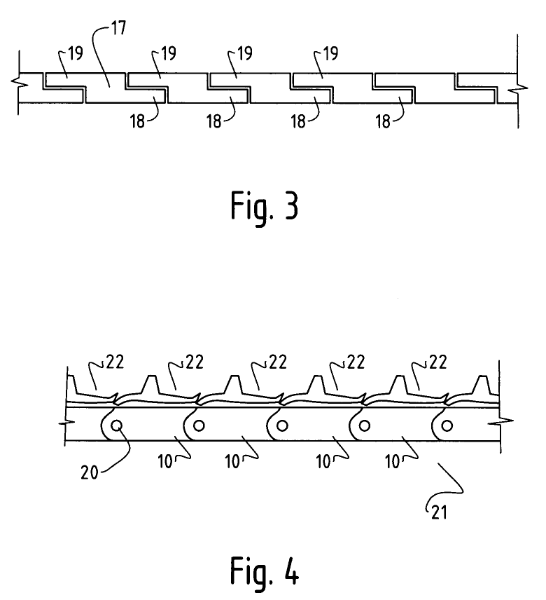

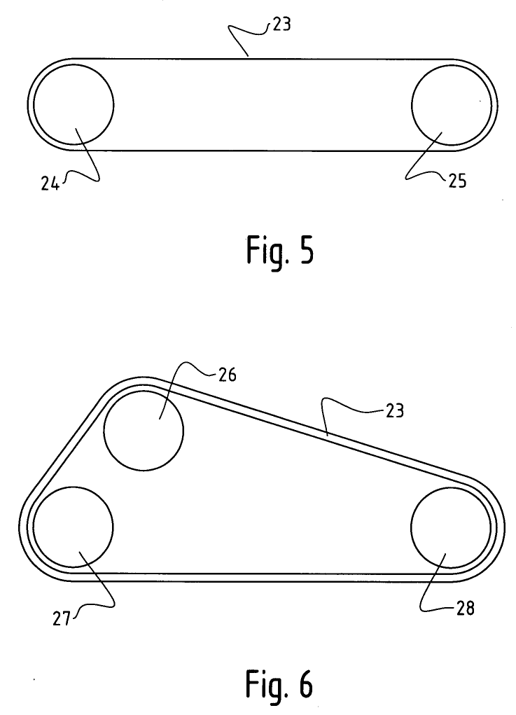

FIGS. 1 to 6 relate to prior art and have been described in the “Background to the Invention” section of this specification.

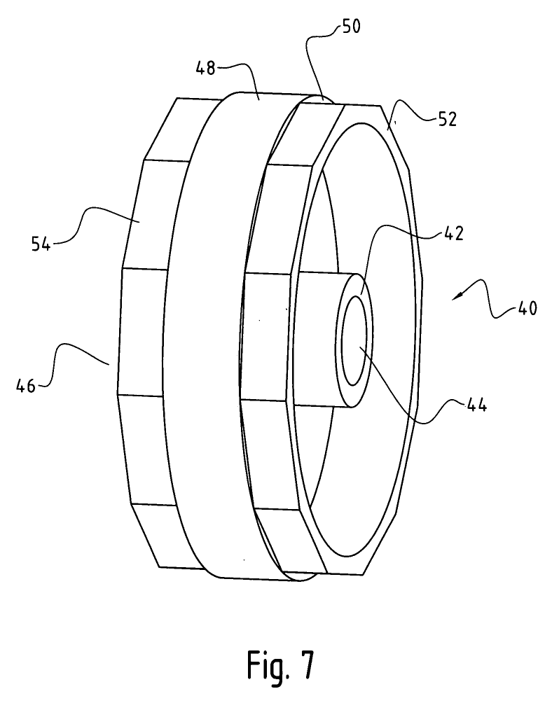

FIGS. 7 to 9 show various views of an idler in accordance with the present invention. The idler shown in FIGS. 7 and 9 is intended for use in track assemblies which include two parallel, spaced track claims that carry track shoes. The idler 40 shown in FIGS. 7 to 9 includes a hub 42 having an opening 44 therethrough. Opening 44 receives a mounting shaft or axle that enables the idler to be mounted to a track frame or to a vehicle. A rim 46 is connected to the hub.

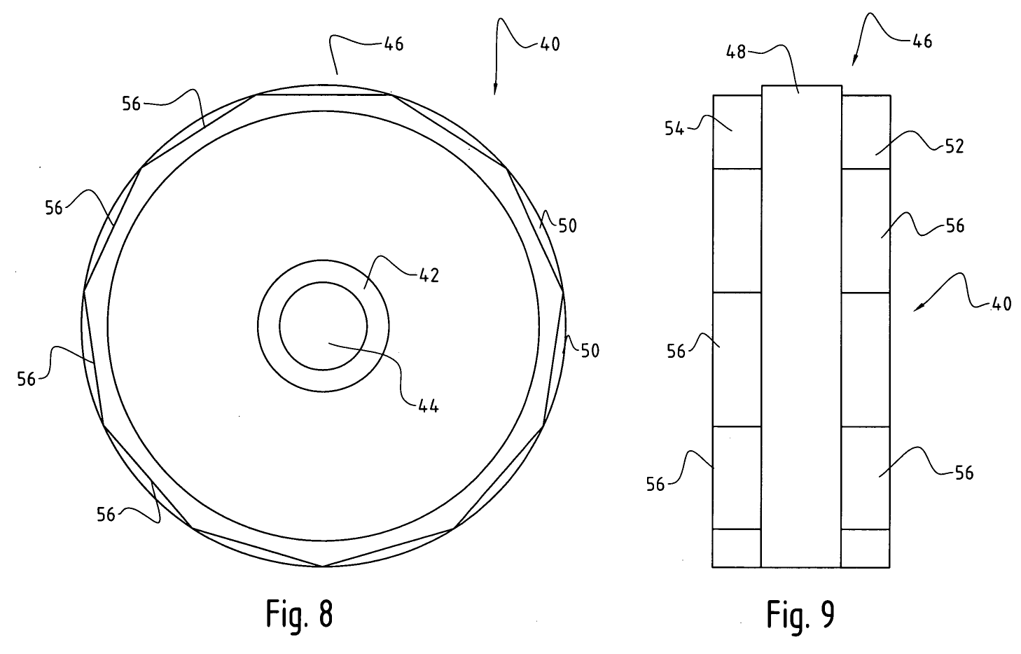

The rim 46 includes a central region 48 that is of larger diameter than the other parts of the rim 46. As can best be seen in FIGS. 7 and 8, central region 48 is generally cylindrical in shape, with a width that is smaller than the width between the two parallel track chains of the track assembly. In this manner, the central region 48 can fit into the space between the parallel track chains as the parallel track chains pass around the idler. This assists in locating and maintaining the track on the idler. The track chains may be fitted with bearings to enable a smooth passage of the track chains over the side walls 50 of central region 48.

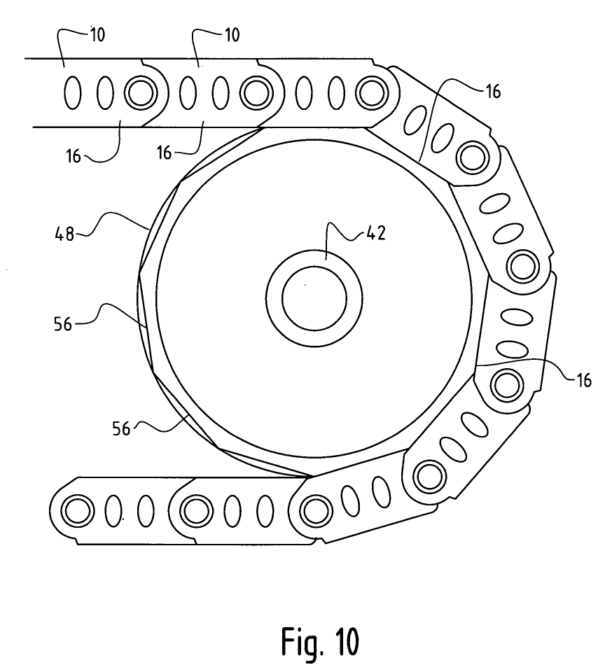

The idler 40 shown in FIGS. 7 to 9 also includes lateral regions 52, 54. Lateral regions 52, 54 preferably do not extend in a radial direction beyond the outer periphery of central region 48, as best shown in FIG. 8. The lateral regions 52, 54 include a plurality of generally flat surfaces 56. The generally flat surfaces 56 come into contact with the lower surface 16 of the track links in the track chain as the track chain passes around the idler 40. This is shown in FIG. 10. As the flat lower surfaces 16 of the track links 10 are in contact with the generally flat surfaces 56 of the idler 40, wear on the lower surfaces 16 of track links 10 is significantly reduced.

As shown in FIG. 10, the length of the generally flat surfaces 56 on the lateral regions of the idler 40 equals the pitch of the links in the track chain. This ensures that the links maintain proper contact with the generally flat surfaces 56, as shown in FIG. 10.

It will be appreciated that the idler shown in FIGS. 7 to 10 is intended for use with a track that includes two parallel track chains that are spaced from each other. If a track assembly includes a track that has a single track chain, the outer periphery of the rim of the idler may comprise the plurality of generally flat surfaces. In such embodiments, the central region 48 shown in FIGS. 7 to 9 may be deleted.

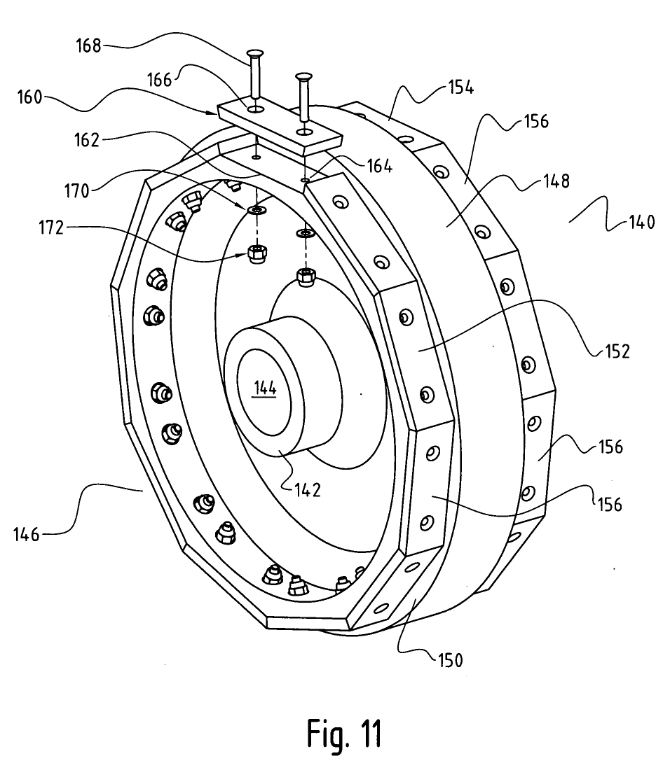

FIG. 11 shows a perspective view of an idler similar to that shown in FIG. 7, but with the generally flat surfaces that come into contact with the track during use comprising removable wear plates. The idler 140 shown in FIG. 11 includes a hub 142 having an opening 144 therethrough. Opening 144 receives a mounting shaft or axle that enables the idler to be mounted to a track frame or to a vehicle. A rim 146 is connected to the hub.

The rim 146 includes a central region 148 that is of larger diameter than the other parts of the rim 146. Central region 148 is generally cylindrical in shape, with a width that is smaller than the width between the two parallel track chains of the track assembly. In this manner, the central region 148 can fit into the space between the parallel track chains as the parallel track chains pass around the idler. This assists in locating and maintaining the track on the idler. The track chains may be fitted with bearings to enable a smooth passage of the track chains over the side walls 150 of central region 148.

The idler 140 shown in FIG. 11 also includes lateral regions 152, 154. Lateral regions 152, 154 preferably do not extend in a radial direction beyond the outer periphery of central region 48. The lateral regions 152, 154 include a plurality of generally flat surfaces 156. The generally flat surfaces 156 come into contact with the lower surface of the track links in the track chain as the track chain passes around the idler 140.

In the embodiment shown in FIG. 11, wear plates 160 are mounted to an underlying surface 162 of the respective lateral regions 154, 156 of the idler 140. As shown in FIG. 11, the underlying surfaces 162 may be generally flat. However, it will be understood that the underlying surfaces 162 are not necessarily flat and that the wear plates 160 may be provided with a lower surface that is of complementary shape to the underlying surface 162. For example, if the underlying surface 162 has an arcuate-shaped upper surface, the lower surface of the wear plate may be of complementary arcuate shape such that it closely fits to the underlying surface.

The underlying surface 162 is provided with bolt holes 164 which come into register or alignment with bolt holes 166 formed in the wear plate 160. Bolts 168 are passed through the bolt holes 166 and 164 and nuts 172 and washers 170 are used to hold the bolts in place and thereby attach the wear plates to the idler 140. Suitably, the heads of the bolts 168 do not extend above the upper surface of the wear plates 160. This assists in presenting a generally flat surface to the track in passing over the idler.

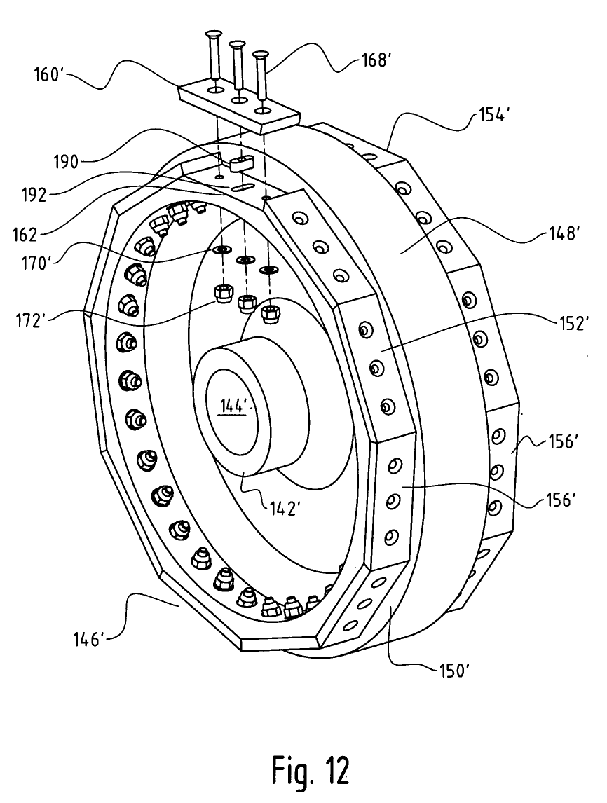

FIG. 12 shows an idler in accordance with another embodiment of the present invention. The embodiment shown in FIG. 12 uses removable wear plates and has a number of features that are common with the embodiment shown in FIG. 11. For convenience, the features shown in FIG. 12 that are common with the embodiment shown in FIG. 11 are denoted by like reference numerals, but with the addition of a “′”. The embodiment shown in FIG. 12 differs from that shown in figure of 11 in that each wear plate 160′ includes three bolt holes. Further, a removable key 190 is positioned such that it rests in a complementary slot 192 formed in the underlying surface 162′ of the idler. Although hidden from view in FIG. 12, a corresponding slot is formed on the underside of wear plate 160′. When fitted, the key 190 fits into the slots formed in the underlying surface 162′ and the underside of the wear plate 160′. The key 190 is used to assist in properly locating the wear plate 160′ when the wear plate is being fitted to the idler. It will be understood that the key 190 may alternatively be formed with the wear plate 160′ or formed integrally with the underlying surface 162′. In those instances, the other of the wear plate or the idler flat surface will be provided with a corresponding slot for the integrally formed key to fit into.

The use of removable wear plates enables worn wear plates to be removed from the idler and replaced with new wear plates. This simplifies refurbishment of worn idlers. The wear plates may be removed whilst the idler is still in place on the machine, thereby reducing the time required to refurbish worn idlers. The wear plates may be available in different thicknesses to accommodate different wear factors on chains or tracks.

Those skilled in the art will appreciate that the present invention may be susceptible to variations and modifications other than those specifically described. It will be understood that the present invention encompasses all such variations and modifications that fall within its spirit and scope.

1. An idler for use on a tracked vehicle of the type having a track that includes a plurality of track links joined together, said track links passing around the idler, said idler including a plurality of generally flat surfaces that come into contact with corresponding generally flat surfaces on the track links as the track links pass around the idler.

2. An idler as claimed in claim 1 wherein each of the plurality of flat surfaces on the idler have a length that matches the link pitch of the track chain formed by the track links.

3. An idler as claimed in claim 1 or claim 2 wherein the track comprises two chains of track links that support track shoes, the two chains of track links being spaced laterally from each other, the chains of track links passing around the idler as the vehicle moves, the idler comprising a region of larger diameter having a width that allows the region of larger diameter to fit into the space between the two chains of track links and lateral regions located on either side of the region of larger diameter, the lateral regions including a plurality of generally flat surfaces that come into contact with corresponding generally flat surfaces on the track links.

4. An idler as claimed in claim 1 wherein the generally flat surfaces are provided by wear plates mounted to the idler.

5. An idler as claimed in claim 4 wherein the wear plates are removably mounted to the idler.

6. An idler as claimed in claim 5 wherein fastening means are used to removably mount the wear plates to the idler.

7. An idler as claimed in claim 5 wherein a key extends between the idler and the wear plate to assist in locating the wear plate.

8. An idler as claimed in claim 7 wherein an underside surface of a wear plate is provided with a slot and a corresponding surface is provided in the idler and the key fits into the slots and is positioned between the idler and the wear plate when the wear plate is fitted to the idler.

9. A track assembly that includes a drive sprocket and an idler as claimed in any one of the preceding claims and a track comprising a plurality of track links joined together to form a track chain, the track links carrying track shoes, said track passing around the idler and the drive sprocket.

10. A tracked vehicle that includes an idler as claimed in claim 1.
